(19) United States
(12) Patent Application Publication
(10) Pub. No.: US 2024/0323217 A1
(43) Pub. Date: Sep. 26, 2024

(54) SYSTEM AND METHOD FOR REDUCTION OF DATA TRANSMISSIONS BY IMPLEMENTATION OF A DATA RETENTION POLICY

(71) Applicant: Dell Products L.P., Round Rock, TX (US)

(72) Inventors: OFIR EZRIELEV, Be'er Sheva (IL); JEHUDA SHEMER, Kfar Saba (IL); RONEN RABANI, Kibuts Telalim (IL)

(21) Appl. No.: 18/187,991

(22) Filed: Mar. 22, 2023

(51) Int. Cl. H04L 9/40; G06F 21/57

(52) U.S. Cl. CPC H04L 63/1433; G06F 21/577; H04L 63/1425; H04L 63/20

(57) ABSTRACT

Methods and systems for authenticating data processing systems throughout a distributed environment without user intervention are disclosed. To do so, a system may include a network core and one or more data processing systems. The network core may attempt to authenticate data processing systems using a security questionnaire. Security questions in the security questionnaire may be based on telemetry data obtained from the data processing system prior to a loss of a root of trust. To conserve computing resources, the network core and data processing systems may implement a data retention policy to identify data points of the telemetry data that meet data security criteria. Data points of the telemetry data that meet the data security criteria may be stored and subsequently used for generation of security questions for re-authentication of data processing systems.

### FIELD

Embodiments disclosed herein relate generally to device authentication. More particularly, embodiments disclosed herein relate to systems and methods to reduce computing resource expenditure while performing device authentication throughout a distributed environment.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2A shows a block diagram illustrating a data processing system interacting with a network core over time in accordance with an embodiment.

FIG. 2B shows a block diagram illustrating a data processing system interacting with a data source and a network core over time in accordance with an embodiment.

FIG. 2C shows a block diagram illustrating a data processing system interacting with a network core over time in accordance with an embodiment.

FIG. 3A shows a flow diagram illustrating a method of device authentication without user intervention in accordance with an embodiment.

FIG. 3B shows a flow diagram illustrating a method of preparing to obtain curated telemetry data from a data processing system in accordance with an embodiment.

FIG. 3C shows a flow diagram illustrating a method of performing a validation of a data processing system in accordance with an embodiment.

FIGS. 4A-4B show block diagrams illustrating a system in accordance with an embodiment over time.

FIG. 5 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

In general, embodiments disclosed herein relate to methods and systems for authentication of data processing systems throughout a distributed environment without user intervention. To authenticate data processing systems throughout a distributed environment without user intervention, the system may include a network core. The network core may initially establish a root of trust with a data processing system of the distributed environment via user intervention (by a user, for example, entering a password, pin, fingerprint scan, etc.). Once the root of trust is established, a secure communication channel may be opened between the network core and the data processing system.

However, the root of trust may become lost due to, for example, a duration of time passing, a password change, a cryptographic key change, etc. Re-establishing the root of trust with the data processing system (e.g., throughout an environment that may be highly distributed with a large number of data processing systems) may be a computationally expensive and time-consuming process. This process may require, for example, a user to re-enter a password, answer security questions, physically re-locate one or more data processing systems, and/or may require other means of user intervention.

To conserve computing resources and efficiently re-establish the root of trust with the data processing system, the system may utilize shared knowledge regarding historical telemetry data obtained from one or more data sources throughout the distributed environment. To do so, the system may collect and store telemetry data following establishment of the root of trust. Therefore, in the event of dissolution of the root of trust, the system may generate a security questionnaire based on the telemetry data.

However, the system may have a limited quantity of computing resources available to accommodate storage of the telemetry data. To conserve computing resources while storing the telemetry data, the system may only retain data points of the telemetry data that meet previously determined criteria. To determine which data points to retain, all data points may be transmitted across a communication system to a network core and the network core may determine which data points meet the criteria. Doing so may consume excess network bandwidth (due to the volume of transmissions required) and/or excess energy by the network core (to analyze all data points of the telemetry data).

To reduce the quantity of transmissions required to establish shared knowledge between the network core and the data processing system (and, therefore, reduce network bandwidth consumption), the system may develop a data retention policy and deploy the data retention policy to both the data processing system and the network core. By doing so, the data processing system may identify data points that meet the criteria indicated by the data retention policy and may transmit only the identified data points to the network core.

Therefore, to re-establish a root of trust with a data processing system, the network core may generate security questions based on data points previously obtained from the data processing system. The system may provide the security questionnaire to the data processing system and may receive a response including answers to each security question in the security questionnaire. If the answers match (at least substantially) pre-determined answers to the security questions, the network core may recognize the data processing system as authentic. Once the data processing system is recognized as authentic, the root of trust may be re-established, and secure communications may resume.

Thus, embodiments disclosed herein may provide an improved system for authenticating data processing systems throughout a distributed environment. Devices may be re-authenticated following dissolution of a root of trust without intervention from a user and using pre-existing shared knowledge already stored by the data processing system for other purposes. By following a data retention policy known to the data processing system and the network core, only data points meeting previously determined criteria may be received by the network core and, therefore, transmissions may be reduced throughout the distributed environment. Consequently, roots of trust may be efficiently re-established as needed throughout a distributed environment while conserving computing resources and without intervention by a user.

In an embodiment, a method of authenticating a data processing system by a network core throughout a distributed environment is provided. The method may include: obtaining curated telemetry data from the data processing system, the curated telemetry data comprising data points that meet data security criteria indicated by a data retention policy; storing the curated telemetry data in a first activity log, the first activity log being maintained identically to a second activity log hosted by the data processing system based on the data retention policy; attempting to improve a security profile of the first activity log based on the data retention policy to obtain an updated first activity log; and performing a validation of the data processing system using a security questionnaire, the security questionnaire comprising security questions based on the updated first activity log.

The method may also include: prior to obtaining the curated telemetry data: obtaining the data retention policy based on a data profile of the data processing system, wherein the data points that meet the data security criteria indicated by the data retention policy are candidate data points for generation of security questions to authenticate the data processing system; and deploying the data retention policy to the data processing system and the network core.

Obtaining the data retention policy may include: establishing a secure connection to the data processing system; obtaining raw telemetry data from the data processing system, the raw telemetry data not being previously curated by the data processing system; performing an analysis of the raw telemetry data to obtain a result, the result indicating a degree of difficulty of predicting a measurement associated with each data point of the raw telemetry data by an adversary; obtaining the data security criteria based on the result and the data profile of the data processing system; and obtaining the data retention policy using, at least in part, the data security criteria.

Performing the analysis may include: obtaining a security score associated with each data point of the raw telemetry data, wherein obtaining the security score comprises: obtaining an inference as output from an inference model trained to generate security scores, the inference comprising the security score.

The inference model may perform anomaly detection, and the security score may indicate a degree of anomalousness of each data point of the raw telemetry data.

The inference model may perform a variability analysis of the raw telemetry data, and the security score may indicate a degree of variability associated with each feature of the raw telemetry data.

The data retention policy may include: instructions for retaining a first portion of the data points that meet the data security criteria; instructions for discarding a second portion of the data points that do not meet the data security criteria; and instructions for discarding a third portion of the data points that meet the data security criteria and are similar to other data points previously marked for retention within a similarity threshold.

The data retention policy may also include: instructions for performing a test for ascertaining whether the data retention policy has aged out.

The method may also include: obtaining an acknowledgement from the data processing system that indicates that the data retention policy has aged out; initiating a data retention policy regeneration process in response to the acknowledgement to obtain an updated data retention policy; and deploying the updated data retention policy to the data processing system and the network core.

Performing the validation of the data processing system may include: identifying an occurrence of an event indicating that the data processing system is to be authenticated; obtaining a security questionnaire, based on the occurrence of the event, using the first activity log and a security risk level of the data processing system; providing the security questionnaire to the data processing system; obtaining a response, the response comprising answers to the security questions in the security questionnaire; making a determination regarding whether each answer of the answers matches a pre-determined answer from a set of possible answers; and in an instance of the determination in which each answer of the answers matches the pre-determined answer: concluding that the data processing system is authentic.

The curated telemetry data may be obtained prior to a loss of a root of trust between the data processing system and the network core.

The validation of the data processing system may be performed without user intervention and concluding that the data processing system is authentic may re-establish the root of trust.

In an embodiment, a non-transitory media is provided that may include instructions that when executed by a processor cause the computer-implemented method to be performed.

In an embodiment, a data processing system is provided that may include the non-transitory media and a processor, and may perform the computer-implemented method when the computer instructions are executed by the processor.

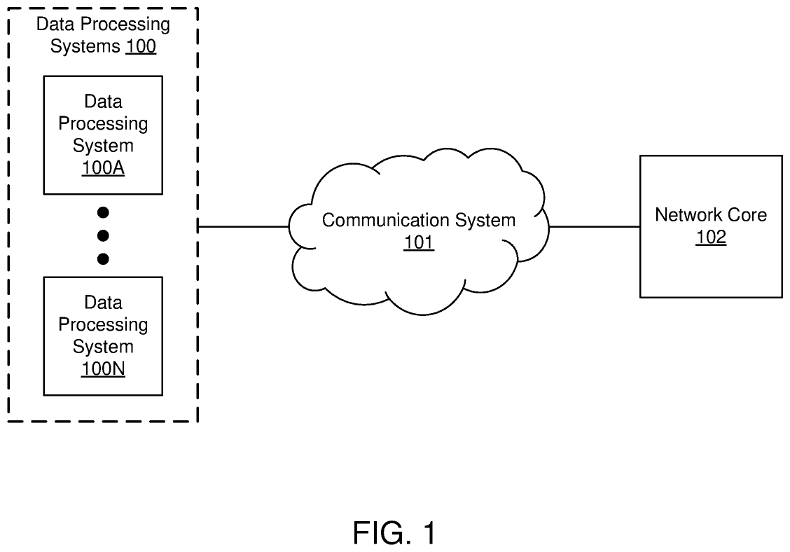

Turning to FIG. 1, a block diagram illustrating a system in accordance with an embodiment is shown. The system shown in FIG. 1 may provide computer-implemented services. The computer-implemented services may include any type and quantity of computer-implemented services. For example, the computer-implemented services may include monitoring services (e.g., of locations), communication services, and/or any other type of computer-implemented services.

To provide the computer-implemented services, the system may include network core 102. Network core 102 may provide all, or a portion of, the computer-implemented services. For example, network core 102 may provide computer-implemented services to users of network core 102 and/or other computing devices operably connected to network core 102. The computer-implemented services may include any type and quantity of services including, for example, authentication of data processing systems throughout a distributed environment.

To facilitate authentication of data processing systems, the system may include one or more data processing systems 100. Data processing systems 100 may include any number of data processing systems (e.g., 100A-100N). For example, data processing systems 100 may include one data processing system (e.g., 100A) or multiple data processing systems (e.g., 100A-100N) that may independently and/or cooperatively facilitate the authentication of data processing systems. Each data processing system of data processing systems 100 may include one or more data sources (not shown) that may perform measurements and provide data based on the measurements to data processing systems 100.

All, or a portion, of data processing systems 100 may provide (and/or participate in and/or support the) computer-implemented services to various computing devices operably connected to data processing systems 100.

The computer-implemented services may include any type and quantity of services including, for example, authentication of data processing systems in a distributed environment. Different data processing systems may provide similar and/or different computer-implemented services.

When providing the computer-implemented services, the system of FIG. 1 may determine whether devices throughout a distributed environment are authenticated prior to exchanging sensitive information. To do so, the system of FIG. 1 may establish a root of trust with each data processing system throughout the distributed environment.

However, roots of trust may be lost and/or otherwise become invalid over time. Re-establishing roots of trust may be a computationally expensive and time-consuming process, as highly distributed environments may include multiple data processing systems that may each individually require re-establishment of roots of trust at different times and/or via different means. Re-establishing a root of trust may require a user to, for example, answer security questions, may require the data processing systems to store additional authentication data, and/or may require other means of intervention by the user. By doing so, undesirable amounts of computing resources may be consumed by the data processing systems and/or the network core (which may each have a limited amount of computing resources available for operation and storage), and delays may occur in operation of the system.

In general, embodiments disclosed herein may provide methods, systems, and/or devices for maintaining authentication of data processing systems throughout a distributed environment without user intervention. To maintain authentication of data processing systems, the system of FIG. 1 may establish a root of trust to any number of data processing systems throughout the distributed environment. Following establishment of the root of trust, the data processing systems may provide the network core with telemetry data. Therefore, both the network core and the data processing systems may maintain substantially identical activity logs storing the telemetry data.

However, the data processing system, the network core, and/or other devices throughout the distributed environment may have a limited quantity of computing resources available to perform actions such as, for example, storing the telemetry data. Therefore, telemetry data may be analyzed to determine whether to store the telemetry data in the activity log.

Receiving all data points and determining which data points to retain may: (i) increase bandwidth consumption required to communicate between the network core and the data processing system, and/or (ii) may increase energy expenditure by network core 102. To reduce communications between the data processing system and network core 102 (and, therefore, decrease network bandwidth consumption), a data retention policy may be obtained and deployed to both the data processing system and the network core.

The data retention policy may include data security criteria and the data processing system may determine whether data points of the telemetry data meet the data security criteria prior to transmitting the telemetry data to the network core. By doing so (and potentially implementing other rules indicated by the data retention policy), only data points that are candidate data points for generating security questions for re-authentication of the data processing system may be transmitted to the network core.

In the event of a dissolution of the root of trust, the network core may utilize the telemetry data in the activity log to generate a security questionnaire. The security questionnaire may include security questions related to past communications, errors, updates, collected data, etc. of the data processing system.

The security questionnaire may be provided to the data processing system and the data processing system may generate a response including answers to the questions in the security questionnaire using the previously stored telemetry data. As the data processing system may already store the telemetry data for other purposes (e.g., data backup, system updates, etc.) accessing the telemetry data to answer questions in the questionnaire may not require additional data to be processed or stored by the data processing system during re-authentication.

The data processing system may provide a response to the network core and the network core may determine whether answers provided in the response match previously determined accepted answers to the questions. If the answers match the previously determined accepted answers (e.g., to a degree considered acceptable), the data processing system may be considered authentic. By doing so, data processing systems may be more efficiently re-authenticated following dissolution of roots of trust throughout a distributed environment. As a distributed environment may include many data processing systems and roots of trust may be lost for various reasons over time, this method of re-establishing roots of trust between the data processing systems and the network core without user intervention may provide a timely and computationally efficient solution.

To provide the above noted functionality, the system of FIG. 1 may include network core 102. Network core 102 may (i) obtain a data retention policy based on a data profile of the data processing system, (ii) deploy the data retention policy to the data processing system, (iii) obtain curated telemetry data from the data processing system, (ii) store the curated telemetry data in a first activity log, (iii) attempt to improve a security profile of the first activity log based on a data retention policy to obtain an updated first activity log, and/or (iv) perform a validation of the data processing system using a security questionnaire, the security questionnaire comprising security questions based on the updated first activity log.

To obtain the data retention policy, network core 102 may obtain raw telemetry data from data processing systems 100 via a secure connection and analyze the raw telemetry data to obtain a result. The result may indicate a degree of difficulty of predicting a measurement associated with each data point of the raw telemetry data by an adversary. Using the result and a data profile of data processing systems 100, network core 102 may obtain data security criteria. The data retention policy may include a set of rules based on the data security criteria indicating how the data security criteria may be used by components of the system.

Attempting to improve the security profile of the first activity log may include implementing rules included in the data retention policy including, for example, aging out and removing data points from the first activity log over time.

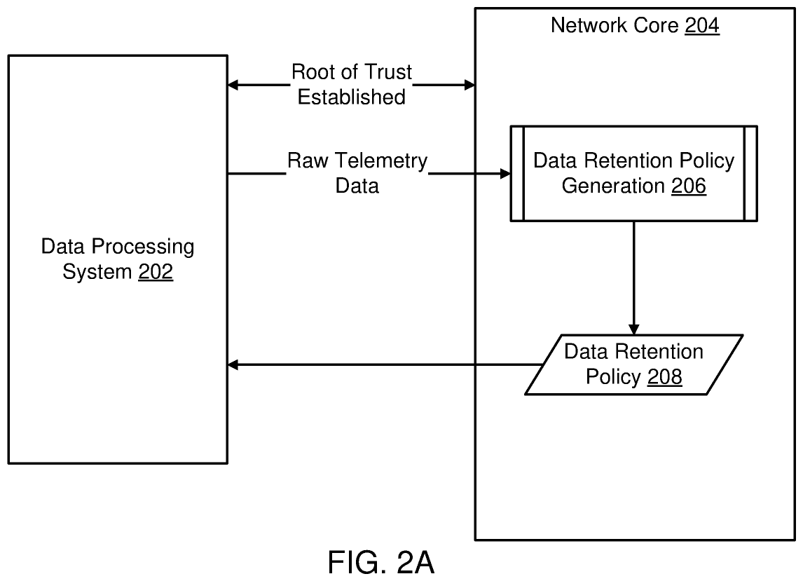

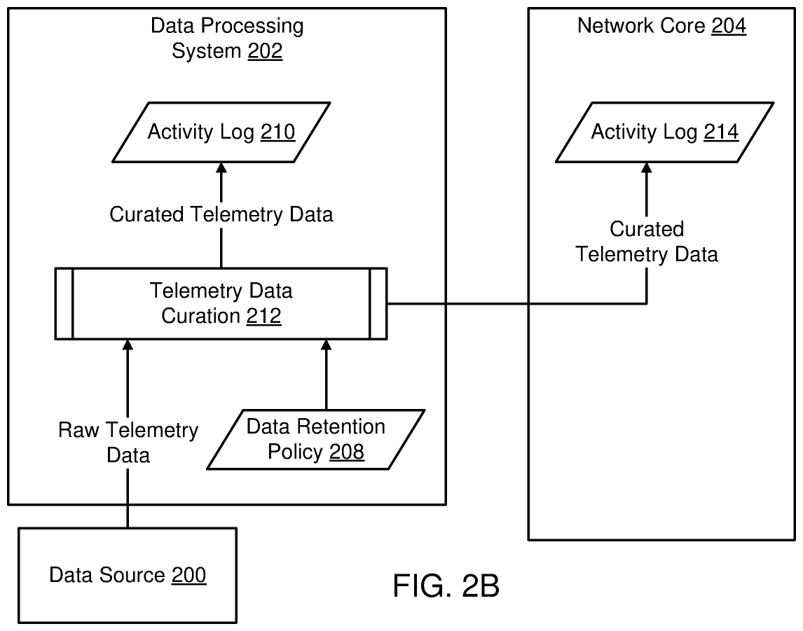

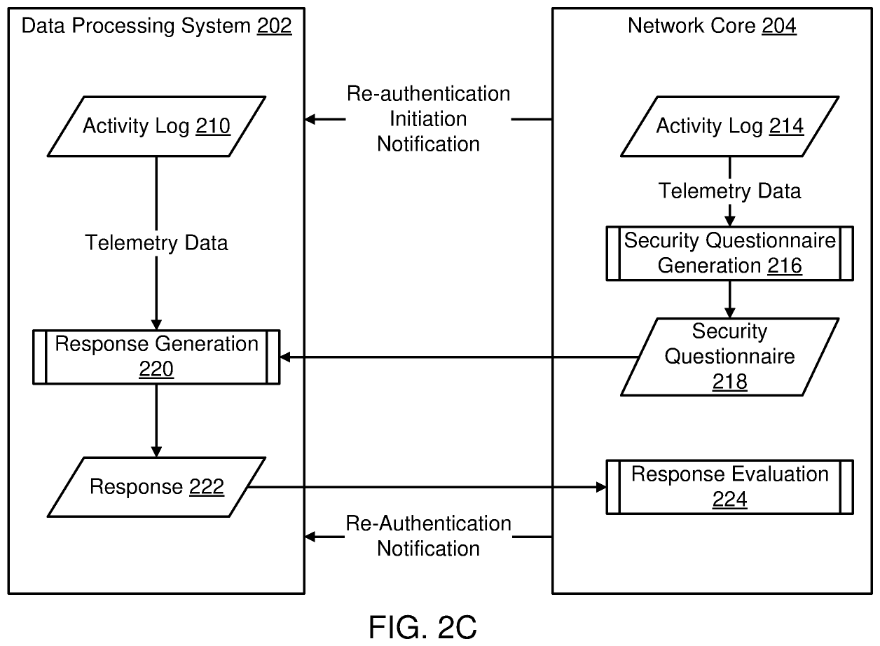

When performing its functionality, network core 102 may perform all, or a portion, of the methods and/or actions shown in FIGS. 2A-4B.

To provide its functionality, data processing systems 100 may: (i) obtain raw telemetry data from a data source, (ii) curate the raw telemetry data using the data retention policy to obtain curated telemetry data, and/or (iii) provide the curated telemetry data to network core 102.

Curating the raw telemetry data may include generating a security score for each data point of the raw telemetry data, the security score indicating a degree of difficulty of predicting the measurement associated with the data point by an adversary and comparing the security score to a security score threshold. Curating the raw telemetry data may also include implementing other rules from the data retention policy, such as discarding measurements similar to other measurements that meet the data security criteria.

When performing its functionality, data processing systems 100 may perform all, or a portion, of the methods and/or actions shown in FIGS. 2A-4B.

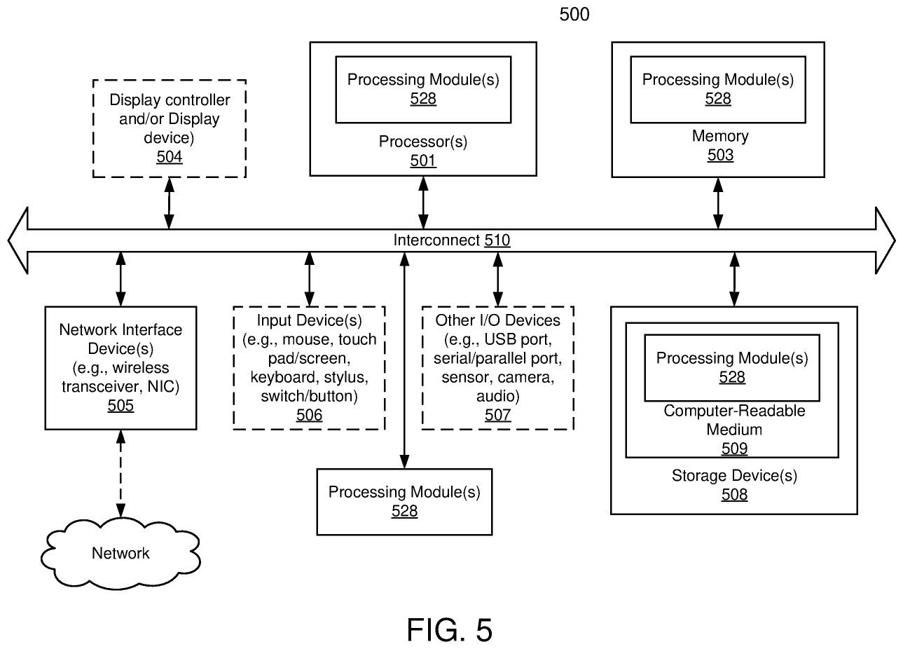

Data processing systems 100 and/or network core 102 may be implemented using a computing device such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 5.

In an embodiment, one or more of data processing systems 100 and/or network core 102 are implemented using an internet of things (IoT) device, which may include a computing device. The IoT device may operate in accordance with a communication model and/or management model known to network core 102, other data processing systems, and/or other devices.

Any of the components illustrated in FIG. 1 may be operably connected to each other (and/or components not illustrated) with a communication system 101. In an embodiment, communication system 101 may include one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, diagrams illustrating data flows and/or processes performed in a system in accordance with an embodiment are shown in FIGS. 2A-2C.

FIG. 2A shows a diagram of data processing system 202 interacting with network core 204. Data processing system 202 may be similar to any of data processing systems 100 and network core 204 may be similar to network core 102. In FIG. 2A, data processing system 202 may be connected to network core 204 via a communication system (not shown). Communications between data processing system 202 and network core 204 are illustrated using lines terminating in arrows.

As discussed with reference to FIG. 1, network core 204 may perform computer-implemented services by authenticating devices throughout a distributed environment.

To authenticate devices, network core 204 may establish a root of trust with data processing system 202. The root of trust may indicate that data processing system 202 is authenticated and may exchange secure communications with network core 204. The root of trust may be established via any means including, for example, a user entering a password, pin, biometric factor, etc.

Data processing system 202 may transmit raw telemetry data to network core 204 and network core 204 may perform data retention policy generation 206 process to generate data retention policy 208. The raw telemetry data may include telemetry data not previously curated by the data processing system. The raw telemetry data may be based on historic activities of the data processing system and may include any data related to the operation of data processing system 202 that may be useful to monitor and/or assess the performance, security, etc. of data processing system 202. For example, telemetry data may include: (i) lifecycle data reflecting operation of data processing system 202, (ii) content of messages transmitted from data processing system 202 to network core 204, (iii) statistics associated with the operation of data processing system 202, (iv) error event data reflecting a subset of operation of data processing system 202, the subset including undesired operation of data processing system 202, and/or other data.

Data retention policy generation 206 process may include performing an analysis of the raw telemetry data to obtain a result, obtaining data security criteria based on the result, and obtaining data retention policy 208 using, at least in part, the data security criteria.

The result may indicate a degree of difficulty of predicting a measurement associated with each data point of the raw telemetry data by an adversary (e.g., with a higher degree of difficulty indicating a less predictable data point). The result may include, for example, a security score for each data point of the raw telemetry data. To perform the analysis, a security score optimization process may be performed using data points of the raw telemetry data. The security score optimization process may include generating a series of potential security questions and a potential security score for each potential security question. The security score may be identified by selecting one or more potential security scores that indicate a highest degree of security for that data point. The security scores may indicate a relative potential security impact of adding each data point of the telemetry data to an activity log (not shown) hosted by network core 204.

Performing the analysis may also include treating the raw telemetry data as ingest for an inference model trained to generate security scores. An inference may be obtained as output from the inference model, the inference including the security score.

As a first example, the inference model may perform anomaly detection and the security score may indicate a degree of anomalousness of each data point of the raw telemetry data. As a second example, the inference model may perform a variability analysis of the raw telemetry data and the security score may indicate a degree of variability associated with each feature of the raw telemetry data. The inference mode may perform other types of analyses without departing from embodiments disclosed herein.

Data retention policy generation 206 process may generate data retention policy 208 using, at least in part, the result a data profile of data processing system 202 (not shown). The data profile of data processing system 202 may indicate a security risk associated with a breach of any number of data sources associated with data processing system 202, a security risk associated with a breach of data processing system 202, patterns and statistics related to historical telemetry data obtained by data processing system 202, and/or other information relevant to determining the data security criteria.

Data retention policy 208 may include the data security criteria. The data security criteria may include one or more thresholds for metrics related to a degree of difficulty of predicting measurements associated with telemetry data by an adversary and/or other criteria. The data points that meet the data security criteria indicated by data retention policy 208 may be candidate data points for generation of security questions to authenticate data processing system 202.

Specifically, data retention policy 208 may include: (i) instructions for retaining a first portion of the data points that meet the data security criteria, (ii) instructions for discarding a second portion of the data points that do not meet the data security criteria, (iii) instructions for discarding a third portion of the data points that meet the data security criteria and are similar to other data points previously marked for retention within a similarity threshold, (iv) instructions for performing a test for ascertaining whether the data retention policy has aged out, and/or (v) instructions for replacing data points stored in the activity log with data points that meet the data security criteria and increase the overall security profile of the activity log.

Following data retention policy generation 206 process, network core 204 may deploy data retention policy 208 to data processing system 202.

Turning to FIG. 2B, a diagram of network core 204 interacting with data processing system 202 is shown.

Following deployment data retention policy 208 to data processing system 202, data processing system 202 may implement data retention policy 208 prior to transmitting additional telemetry data to network core 204. Data processing system 202 may only transmit data points of the telemetry data that meet data security criteria (and/or other criteria) indicated by the data retention policy thereby decreasing transmissions across the communication system and subsequently decreasing network bandwidth usage throughout the distributed environment.

Data processing system 202 may obtain raw telemetry data from data source 200. Data source 200 may be any data source (e.g., a sensor positioned to collect measurements of an environment) and data source 200 may include any number of data sources.

Data processing system may perform telemetry data curation 212 process using the raw telemetry data and data retention policy 208 to obtain curated telemetry data. Telemetry data curation 212 process may include obtaining a security score for each data point of the raw telemetry data, comparing the security scores to a security score threshold, selecting data points with a security score that exceeds the security score threshold as the curated telemetry data, and/or other actions.

The curated telemetry data may include data points of the raw telemetry data that meet the data security criteria indicated by data retention policy 208 and, therefore, are candidate data points for generation of security questions to authenticate data processing system 202. The curated telemetry data may be stored in activity log 210 hosted by data processing system 202 and transmitted to network core 204 for storage in activity log 214. Activity log 214 may be maintained identically to activity log 210 hosted by data processing system 202 based on data retention policy 208. Consequently, data processing system 202 and network core 204 may maintain substantially identical activity logs from which to generate security questions for authenticating data processing system 202.

Turning to FIG. 2C, a diagram of data processing system 202 and network core 204 is shown.

The root of trust established in FIG. 2A may become invalid due to, for example, password changes, cryptographic key exposure, security certificate changes, and/or for other reasons. If the root of trust is lost, network core 204 may transmit a re-authentication initiation notification to data processing system 202. Data processing system 202 may transmit a response (not shown) to establish that data processing system 202 is ready to participate in a re-authentication process.

To re-authenticate data processing system 202 without user intervention, network core 204 may perform security questionnaire generation 216 process. Security questionnaire generation 216 process may include generating security questionnaire 218 using telemetry data from activity log 214. As described in FIG. 2B, activity log 214 may include curated telemetry data known to data processing system 202 and network core 204, the curated telemetry data being obtained prior to a loss of a root of trust between data processing system 202 and network core 204. Activity log 210 and activity log 214 may be exclusively used for re-establishing a root of trust between data processing system 202 and network core 204 after the root of trust is lost.

To perform security questionnaire generation 216 process, network core 204 may obtain telemetry data from activity log 214 and may populate security questionnaire 218 with a series of security questions based on data points chosen from the telemetry data. Network core 204 may also generate a set of acceptable answers to the security questions.

Network core 204 may transmit security questionnaire 218 to data processing system 202. Data processing system 202 may perform response generation 220 process using the security questionnaire to generate response 222. Response generation 220 process may include retrieving a portion of the telemetry data from activity log 210 to compile answers the security questions. Response 222 may include answers that are responsive to security questions of security questionnaire 218.

Data processing system 202 may transmit response 222 to network core 204 and network core 204 may perform response evaluation 224 process using the response 222 and the previously established set of acceptable answers (not shown). If the answers in response 222 match the answers in the set of acceptable answers (to a degree considered acceptable by network core 204), data processing system 202 may be concluded to be authentic. If the answers in response 222 do not match the answers in the set of acceptable answers, data processing system 202 may not be concluded to be authentic.

In response to concluding that data processing system 202 is authentic, network core 204 may transmit a re-authentication notification to notify data processing system 202 of successful re-authentication and, therefore, a re-establishment of the root of trust. By re-authenticating data processing system 202 using telemetry data already stored by data processing system 202 and without user intervention, authentication of devices throughout a distributed environment may be timely and computationally efficiently maintained.

In an embodiment, network core 204 is implemented using a processor adapted to execute computing code stored on a persistent storage that when executed by the processor performs the functionality of network core 204 discussed throughout this application. The processor may be a hardware processor including circuitry such as, for example, a central processing unit, a processing core, or a microcontroller. The processor may be other types of hardware devices for processing information without departing from embodiments disclosed herein.

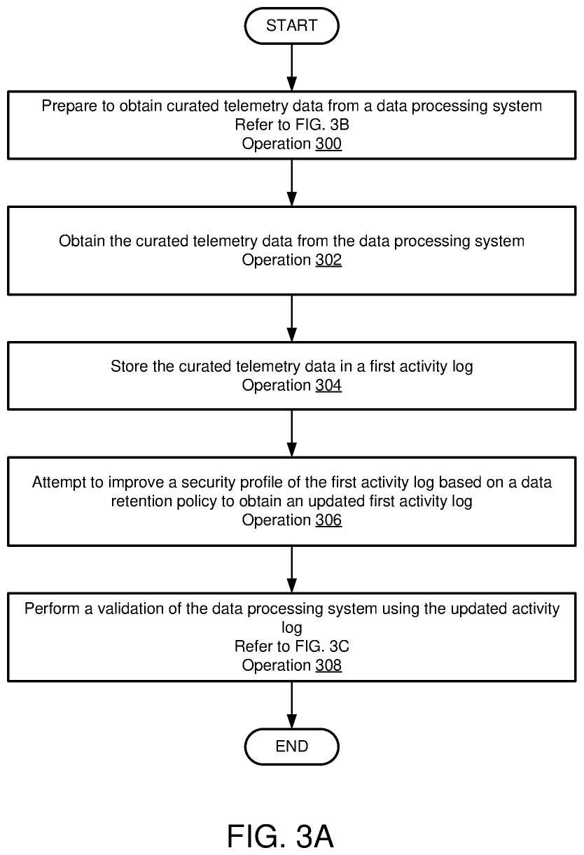

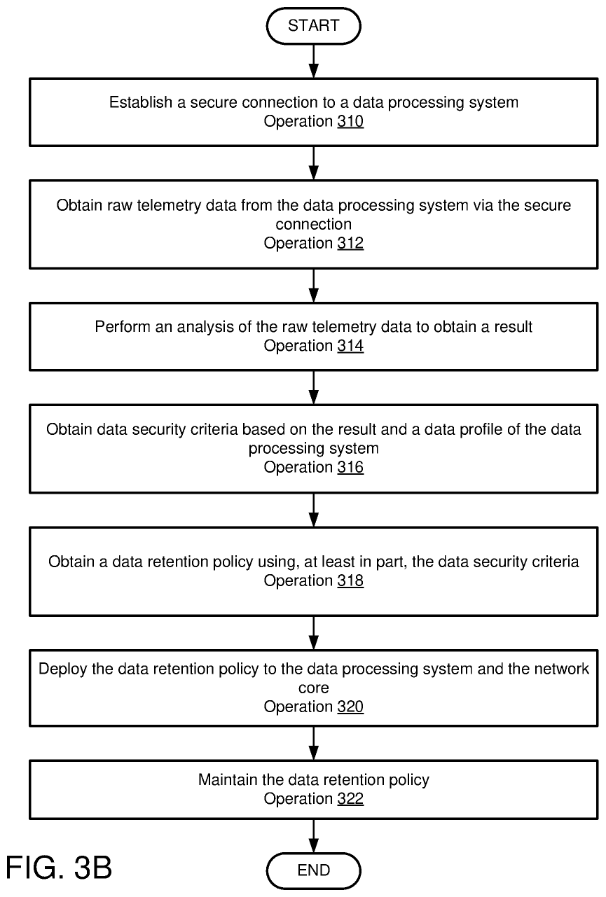

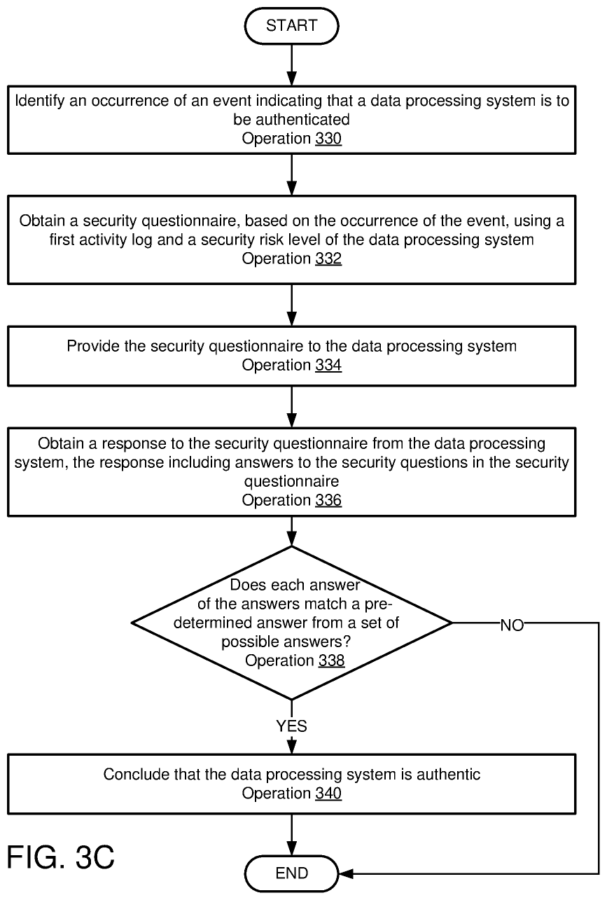

As discussed above, the components of FIG. 1 may perform various methods to perform device authentication in a distributed environment without user intervention. FIGS. 3A-3C illustrate methods that may be performed by the components of FIG. 1. In the diagrams discussed below and shown in FIGS. 3A-3C, any of the operations may be repeated, performed in different orders, and/or performed in parallel with or in a partially overlapping in time manner with other operations.

Turning to FIG. 3A, a flow diagram a method of a method of device authentication without user intervention is shown. The method may be performed, for example, by a network core, data processing system, and/or any other device.

At operation 300, the system prepares to obtain curated telemetry data from a data processing system. Preparing to obtain curated telemetry data from a data processing system may include: (i) establishing a secure connection to the data processing system, (ii) obtaining raw telemetry data from the data processing system via the secure connection, (iii) performing an analysis of the raw telemetry data to obtain a result, (iv) obtaining data security criteria based on the result and a data profile of the data processing system, (v) generating a data retention policy using, at least in part, the data security criteria, and/or (vi) deploying the data retention policy to the data processing system and the network core. Refer to FIG. 3B for additional details regarding preparing to obtain curated telemetry data from the data processing system.

At operation 302, the curated telemetry data is obtained from the data processing system. The curated telemetry data may be obtained in the form of a message via the secure connection, may be read from a database of curated telemetry data, and/or may be obtained via other methods. The curated telemetry data may be obtained continuously, at regular intervals, and/or when requested by the network core. The curated telemetry data may also be transmitted to another trusted device and the curated telemetry data may be obtained from the trusted device.

At operation 304, the curated telemetry data is stored in a first activity log. Storing the curated telemetry data in the first activity log may include generating a data structure to act as the first activity log. The curated telemetry data may also be added to an existing data structure to update the first activity log. The curated telemetry data may also be transmitted (via a secure connection) to another device responsible for storing the curated telemetry data in the first activity log.

At operation 306, improving a security profile of the first activity log is attempted based on a data retention policy to obtain an updated first activity log. Attempting to improve the security profile of the first activity log may include: (i) obtaining the data retention policy, and/or (ii) implementing the data retention policy. Refer to FIG. 3B for additional details regarding obtaining the data retention policy.

Implementing the data retention policy may include, for example, determining that a first data point stored in the first activity log has aged out and removing the first data point from the first activity log. Implementing the data retention policy may include other actions without departing from embodiments disclosed herein.

Attempting to improve the security profile of the first activity log may also include monitoring a membership of data points in the activity log. Monitoring the membership of the data points in the first activity log may include: (i) obtaining an updated security score for a data point stored in the updated activity log, (ii) determining whether the updated security score exceeds the security score threshold, (iii) if the updated security score exceeds the security score threshold, maintaining the data point in the updated activity log, and/or (iv) if the updated security score does not exceed the security score threshold, removing the data point from the updated activity log and updating the available storage capacity of the updated activity log.

At operation 308, a validation of the data processing system is performed using the updated activity log. Performing the validation of the data processing system may include: (i) identifying an occurrence of an event indicating that the data processing system is to be authenticated, (ii) obtaining a security questionnaire, based on the occurrence of the event, using a first activity log. (iii) providing the security questionnaire to the data processing system, (iv) obtaining a response from the data processing system, the response including answers to the security questions in the security questionnaire, (v) determining whether each answer of the answers matches a pre-determined answer from a set of possible answers, and/or (vi) if each answer of the answers matches the pre-determined answer, concluding that the data processing system is authentic. Refer to FIG. 3C for additional details regarding performing the validation of the data processing system.

The method may end following operation 308.

Turning to FIG. 3B, a flow diagram illustrating a method of preparing to obtain curated telemetry data from a data processing system in accordance with an embodiment is shown. The method may be performed, for example, by a network core, data processing system, and/or any other device. The operations shown in FIG. 3B may be an expansion of operation 300 in FIG. 3A.

Preparing to obtain curated telemetry data from the data processing system may include obtaining a data retention policy and deploying the data retention policy to the data processing system. The data retention policy may be obtained and deployed during setup of the system and/or over time as needed.

At operation 310, a secure connection is established to the data processing system. The secure connection may be established by: (i) establishing a root of trust between the network core and the data processing system via user intervention, and (ii) while the root of trust is in place, using the root of trust to establish a secure communication channel between the network core and the data processing system.

The root of trust may be established via a user providing an authentication factor (e.g., a password, a pin, a fingerprint, etc.). The user may provide the authentication factor by interacting with a graphical user interface (GUI) on a device (e.g., the data processing system and/or another device throughout the distributed environment). The root of trust may also be established via the user traveling to a particular location with a physical item (e.g., a token, card, etc.). Combinations of authentication factors may also be used (e.g., a card and a password) to establish the root of trust. To establish the secure communication channel, the network core may transmit a shared secret (e.g., a secure cryptographic key) to the data processing system via a communication system.

At operation 312, raw telemetry data is obtained from the data processing system via the secure connection. The raw telemetry data may be obtained in the form of a message via the secure connection, may be read from a database storing raw telemetry data, and/or may be obtained via other methods. The raw telemetry data may be obtained continuously, at regular intervals, and/or when requested by the network core. The raw telemetry data may also be transmitted to another trusted device and the telemetry data may be obtained from the trusted device.

At operation 314, an analysis of the raw telemetry data is performed to obtain a result. Performing the analysis may include obtaining a security score associated with each data point of the raw telemetry data, obtaining another metric indicating the degree of difficulty of predicting a measurement represented by each data point of the raw telemetry data by an adversary, and/or any other action without departing from embodiments disclosed herein.

Obtaining the security score may include performing a security score optimization process. The security score optimization process may include: (i) generating one or more potential security questions based on the data point, (ii) generating a potential security score for each potential security question of the one or more potential security questions, (iii) identifying one or more of the potential security scores that indicate a highest degree of security, and/or (iv) assigning the security score based on the one or more potential security scores that indicate the highest degree of security.

Obtaining the security score may also include obtaining an inference as output from an inference model trained to generate security scores.

The inference model may be obtained by (i) reading the inference model from storage, (ii) receiving the inference model from another device, and/or (iii) generating the inference model, for example by programming a data processing system and/or another device and training the inference model using training data. The inference model may be a particular type of inference model, such as a linear regression model, a deep neural network, a decision tree, etc.

The inference may be obtained by feeding ingest data (e.g., the raw telemetry data) to the trained inference model. The trained inference model may produce the inference (e.g., the security scores) as output in response to the ingest data. The inference may also be obtained by transmitting the ingest data to another entity responsible for hosting and operating the inference model and requesting the inference from the entity.

Security scores may be assigned based on other criteria and via other methods without departing from embodiments disclosed herein.

At operation 316, data security criteria are obtained based on the result and a data profile of the data processing system. Obtaining the data security criteria may include feeding the result, the data profile, and/or any other data into an inference model and/or a rules-based engine trained to generate data security criteria associated with data processing systems. The data security criteria may also be obtained by reading the data security criteria from storage and/or transmitting the result, the data profile, and/or any other data to another entity responsible for generating the data security criteria.

At operation 318, a data retention policy is obtained using, at least in part, the data security criteria. Obtaining the data retention policy may include: (i) reading the data retention policy from storage, (ii) providing the data security criteria to another entity responsible for generating data retention policies and receiving the data retention policy in response, and/or (iii) generating the data retention policy.

Generating the data retention policy may include feeding the data security criteria, the data profile, and/or other data into an inference model and/or a rules-based engine and obtaining a set of rules as output from the inference model. The set of rules may be treated as the data retention policy. The data retention policy may be generated via other methods without departing from embodiments disclosed herein.

At operation 320, the data retention policy is deployed to the data processing system and the network core. Deploying the data retention policy may include storing the data retention policy in storage (locally or off-site), transmitting the data retention policy to an entity, transmitting instructions for how to retrieve the data retention policy from a database, and/or other actions.

At operation 322, the data retention policy is maintained. As previously mentioned, the data retention policy may be obtained and deployed during setup of the system and/or over time as needed. For example, the data retention policy may age out after a duration of time. Maintaining the data retention policy may include: (i) obtain an acknowledgement from the data processing system that indicates that the data retention policy has aged out, (ii) initiate a data retention policy regeneration process in response to the acknowledgement to obtain an updated data retention policy, and/or (iii) deploy the updated data retention policy to the data processing system and the network core.

Obtaining the acknowledgement may include obtaining a message in the form of a transmission over a communication system from the data processing system, may include reading the acknowledgement from storage, obtaining the acknowledgement as a notification in an application on a device, and/or obtaining the acknowledgement via other methods.

Initiating the data retention policy regeneration process may include: (i) discarding the data retention policy, (ii) transmitting a notification to other entities to discard the data retention policy, (iii) generating the updated data retention policy via the methods described in operations 310-318, and/or (iv) other actions.

Deploying the updated data retention policy may include storing the data retention policy in storage (locally or off-site), transmitting the data retention policy to an entity, transmitting instructions for how to retrieve the data retention policy from a database, and/or other actions.

The method may end following operation 322.

Turning to FIG. 3C, a flow diagram illustrating a method of performing a validation of a data processing system in accordance with an embodiment is shown. The method may be performed, for example, by a network core, data processing system, and/or any other device. The operations shown in FIG. 3C may be an expansion of operation 308 in FIG. 3A.

At operation 330, an occurrence of an event indicating that a data processing system is to be authenticated is identified. The occurrence of the event may place the previously established secure communication channel into a potentially compromised state. The occurrence of the event may be identified by: (i) receiving a notification that the secure connection has been lost, and/or (ii) terminating the secure connection. The secure connection may be terminated in response to an identification of: (i) a password change, (ii) exposure of the cryptographic key, (iii) a security certificate time-out, and/or other reasons.

At operation 332, a security questionnaire is obtained, based on the occurrence of the event, using a first activity log and a security risk level of the data processing system. Obtaining the security questionnaire may include: (i) obtaining curated telemetry data from an activity log, (ii) obtaining at least one security question based on the curated telemetry data, and/or (iv) obtaining the security questionnaire using, at least in part, the at least one security question.

The curated telemetry data may be obtained by accessing the first activity log using access credentials, requesting the curated telemetry data from an entity hosting the first activity log, and/or via other methods.

Obtaining the at least one security question may include: (i) obtaining a first data point stored in the first activity log, (ii) obtaining a first security question based on the first data point, (iii) obtaining a second data point stored in the first activity log, and/or (iv) obtaining a second security question based on the second data point. The first data point and the second data point may be chosen based on the security risk level associated with the data processing system to be re-authenticated (a level of risk associated with a potential security breach of the data processing system).

The first data point may be obtained by accessing the first activity log using access credentials, via requesting access to the first activity log from another entity responsible for hosting the first activity log, and/or via other methods. After accessing the first activity log, the first data point may be obtained by randomly selecting a data point from the first activity log, by selecting a data point listed first in the first activity log, and/or using other selection criteria. The first data point may also be obtained by requesting the first data point from another entity responsible for selecting the first data point. The second data point may be obtained using similar methods to those described above with respect to the first data point.

The first security question may be obtained by feeding the first data point into an inference model or rules-based engine trained to form security questions based on data points. The first security question may also be obtained by transmitting the first data point to another entity responsible for generating security questions and receiving the first security question as a response from the entity. The second security question may be obtained using methods similar to those described above with respect to the first security question.

The security questionnaire may be obtained by populating the security questionnaire with the at least one security question. The security questionnaire may be populated with the at least one security question by generating a data structure to be treated as the security questionnaire and adding the at least one security question to the data structure. The at least one security question may also be added to an existing security questionnaire and previous security questions may be adapted, deleted, or analyzed to determine continued relevance.

The security questionnaire may be populated with the at least one security question by transmitting the at least one security question to another device responsible for generating the security questionnaire based on security questions.

Obtaining the security questionnaire may also include obtaining a pre-determined answer for each security question of the security questionnaire. The pre-determined answer for security question of the security questionnaire may be obtained by feeding the security questionnaire and at least a portion of the curated telemetry data into an inference model trained to generate possible acceptable answers to each security question of the security questionnaire. The possible acceptable answers may be added to a (previously generated or newly generated) data structure to be treated as the answers.

At operation 334, the security questionnaire is provided to the data processing system. The security questionnaire may be provided to the data processing system by transmitting the security questionnaire to the data processing system over a communication system. The security questionnaire may be transmitted automatically when the security questionnaire is generated, may be transmitted upon receipt of a notification that the data processing system is ready to receive the security questionnaire and/or may be transmitted based on any other schedule. The security questionnaire may be provided to the data processing system by sending a notification to another device storing the security questionnaire to transmit the security questionnaire to the data processing system.

At operation 336, a response to the security questionnaire is obtained from the data processing system, the response including answers to the security questions in the security questionnaire. The response may be obtained via a message transmitted by the data processing system over the communication system, by reading the response from storage, by accessing the response from a database storing responses, and/or via other methods. Obtaining the response may include decrypting the response using a previously shared cryptographic key, generating a hash of the pre-determined answers to compare to a hash included in the response, and/or other security measures.

At operation 338, it is determined whether each answer of the answers matches a pre-determined answer from a set of possible answers. If each answer of the answers matches the pre-determined answer from the set of possible answers, the method may proceed to operation 340. If each answer of the answers does not match the pre-determined answer from the set of possible answers, the method may end following operation 338.

Whether each answer of the answers matches a pre-determined answer from a set of possible answers may be determined by: (i) obtaining a first answer from the response, the first answer corresponding to a first security question of the at least one security questions, (ii) determining whether the first answer matches a corresponding pre-determined answer from the set of possible answers, and (iii) if the first answer matches the corresponding pre-determined answer, treating the first answer as accurate.

Obtaining the first answer from the response may include parsing the response into answers to each security question and selecting one of the answers to one of the security questions as the first answer. The first answer may be selected at random, may be selected by selecting the first question in the security questionnaire, and/or may be selected via another selection methodology. The response may also be transmitted to another device responsible for selecting the first answer.

To determine whether the first answer matches the pre-determined answer from the set of possible answers, the pre-determined answer may be obtained. The pre-determined answer (or answers) corresponding to the security question may be selected from the set of possible answers, and the first answer may be compared to the pre-determined answer or answers. If the first answer matches the pre-determined answers (at least substantially or to an extent determined acceptable), the first answer may be considered accurate.

The above-described process may be repeated for each answer included in the response until all answers included in the response have been determined to be accurate or inaccurate.

At operation 340, the data processing system is concluded to be authentic. The data processing system may be concluded to be authentic without the user intervention. Concluding the data processing system to be authentic may include evaluating the accuracy of answers in the response to determine whether the response is accurate enough to consider the data processing system to be authentic. Evaluating the accuracy of the answers in the response may include comparing the number of correct answers to a previously determined amount of acceptable correct answers. Evaluating the accuracy of the answers may be performed via other means, such as comparing a percent accuracy to an acceptable percentage of accuracy, etc. If the answers in the response are considered acceptably accurate, the data processing system may be concluded to be authentic, and the root of trust may be re-established without user intervention. Re-establishing the root of trust may include establishing a new secure communications channel to the data processing system and distributing a new cryptographic key to the data processing system.

The method may end following operation 340.

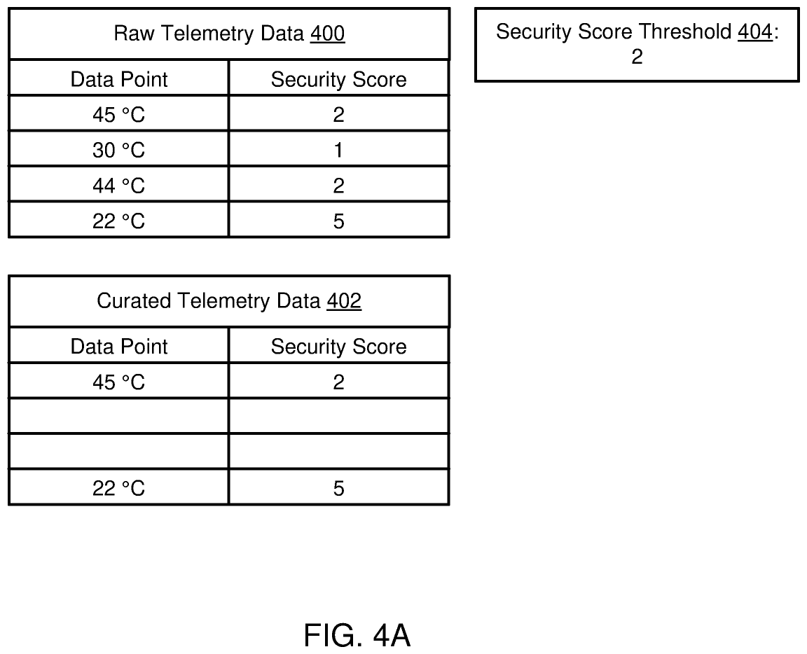

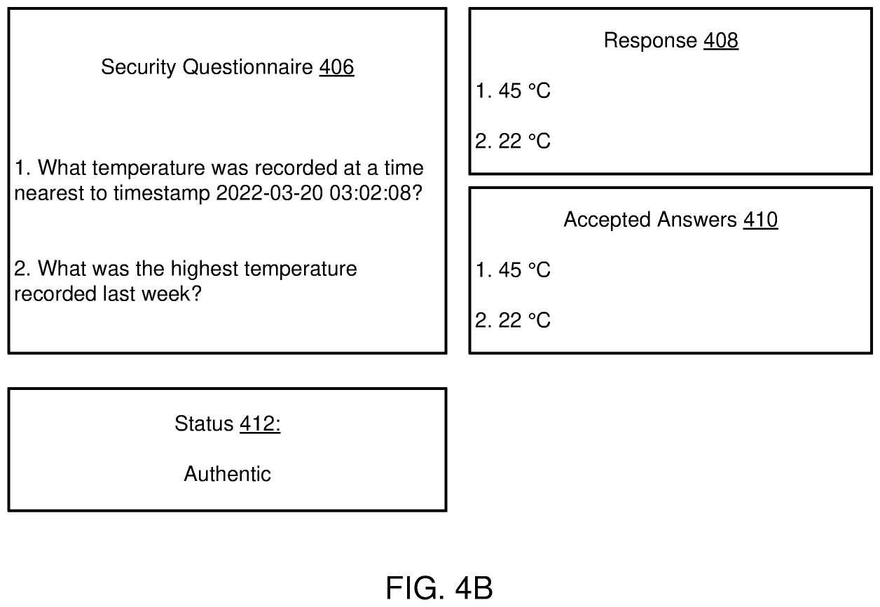

Turning to FIG. 4A, consider a scenario in which a root of trust is established between a data processing system and a network core. The data processing system and the network core may both have access to a data retention policy and the data processing system may implement the data retention policy prior to transmitting any telemetry data to the network core.

The data processing system may obtain raw telemetry data 400 from one or more data sources. Each data point of raw telemetry data 400 may have an associated security score indicating a degree of difficulty of predicting the measurement associated with the data point by an adversary. The data processing system may implement the data retention policy (not shown) to curate raw telemetry data 400 and obtain curated telemetry data 402.

The data retention policy may include criteria such as security score threshold 404 indicating that only data points with a security score of 2 or above may be transmitted to the network core. Therefore, the second data point of raw telemetry data 400 (30° C. with a security score of 1) may not be added to curated telemetry data 402. The data retention policy may also indicate that if two or more data points fall within a range of ±1° C. and have the same security score, only one of the data points may be retained. Therefore, the first data point (45° C. with a security score of 2) may be added to curated telemetry data 402 and the third data point (44° C. with a security score of 2) may not be added to curated telemetry data 402. The fourth data point (22° C. with a security score of 5) may be added to curated telemetry data 402 due to the security score of the fourth data point exceeding security score threshold 404.

Therefore, curated telemetry data 402 may be transmitted to the network core and the network core may store curated telemetry data 402 in an activity log.

Turning to FIG. 4B, the previously established root of trust may be lost between the data processing system and the network core. To re-establish the root of trust, the network core may generate security questionnaire 406 based on curated telemetry data 402. The quantity and type of security questions included in security questionnaire 406 may be based on a security risk level of the data processing system and/or other criteria.

As shown in FIG. 4B, the first question may request temperature recorded at a time nearest to timestamp 2022-03-20 03:02:08 and a second question may request the highest temperature recorded the previous week. Security questionnaire 406 may be transmitted to the data processing system (not shown).

Response 408 may be received from the data processing system following transmission of security questionnaire 406 to the data processing system. Response 408 may include answers to the security questions included in security questionnaire 406. The answers in response 408 may be generated by the data processing system without user intervention based on an activity log matching an activity log hosted by the network core.

Accepted answers 410 may be generated by the network core and may include responses to the security questions that are considered accurate. The answers of accepted answers 410 may be generated using security questionnaire 406 and the curated telemetry data. The network core may compare the answers in response 408 to the answers in accepted answers 410 to determine whether the data processing system is authentic. In this scenario, the answers of response 408 may match the answers of accepted answers 410 and the data processing system may be assigned status 412 of authentic. As a result, the root of trust may be re-established with the data processing system and secure communications may resume between the network core and the data processing system.

Any of the components illustrated in FIGS. 1-4B may be implemented with one or more computing devices. Turning to FIG. 5, a block diagram illustrating an example of a data processing system (e.g., a computing device) in accordance with an embodiment is shown. For example, system 500 may represent any of data processing systems described above performing any of the processes or methods described above. System 500 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 500 is intended to show a high level view of many components of the computer system. However, it is to be understood that additional components may be present in certain implementations and furthermore, different arrangement of the components shown may occur in other implementations. System 500 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 500 includes processor 501, memory 503, and devices 505-507 via a bus or an interconnect 510. Processor 501 may represent a single processor or multiple processors with a single processor core or multiple processor cores included therein. Processor 501 may represent one or more general-purpose processors such as a microprocessor, a central processing unit (CPU), or the like. More particularly, processor 501 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 501 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 501, which may be a low power multi-core processor socket such as an ultra-low voltage processor, may act as a main processing unit and central hub for communication with the various components of the system. Such processor can be implemented as a system on chip (SoC). Processor 501 is configured to execute instructions for performing the operations discussed herein. System 500 may further include a graphics interface that communicates with optional graphics subsystem 504, which may include a display controller, a graphics processor, and/or a display device.

Processor 501 may communicate with memory 503, which in one embodiment can be implemented via multiple memory devices to provide for a given amount of system memory. Memory 503 may include one or more volatile storage (or memory) devices such as random access memory (RAM), dynamic RAM (DRAM), synchronous DRAM (SDRAM), static RAM (SRAM), or other types of storage devices. Memory 503 may store information including sequences of instructions that are executed by processor 501, or any other device. For example, executable code and/or data of a variety of operating systems, device drivers, firmware (e.g., input output basic system or BIOS), and/or applications can be loaded in memory 503 and executed by processor 501. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 500 may further include IO devices such as devices (e.g., 505, 506, 507, 508) including network interface device(s) 505, optional input device(s) 506, and other optional IO device(s) 507. Network interface device(s) 505 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 506 may include a mouse, a touch pad, a touch sensitive screen (which may be integrated with a display device of optional graphics subsystem 504), a pointer device such as a stylus, and/or a keyboard (e.g., physical keyboard or a virtual keyboard displayed as part of a touch sensitive screen). For example, input device(s) 506 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 507 may include an audio device. An audio device may include a speaker and/or a microphone to facilitate voice-enabled functions, such as voice recognition, voice replication, digital recording, and/or telephony functions. Other IO devices 507 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 507 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 510 via a sensor hub (not shown), while other devices such as a keyboard or thermal sensor may be controlled by an embedded controller (not shown), dependent upon the specific configuration or design of system 500.

To provide for persistent storage of information such as data, applications, one or more operating systems and so forth, a mass storage (not shown) may also couple to processor 501. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as a SSD cache to enable non-volatile storage of context state and other such information during power down events so that a fast power up can occur on re-initiation of system activities. Also a flash device may be coupled to processor 501, e.g., via a serial peripheral interface (SPI). This flash device may provide for non-volatile storage of system software, including a basic input/output software (BIOS) as well as other firmware of the system.

Storage device 508 may include computer-readable storage medium 509 (also known as a machine-readable storage medium or a computer-readable medium) on which is stored one or more sets of instructions or software (e.g., processing module, unit, and/or processing module/unit/logic 528) embodying any one or more of the methodologies or functions described herein. Processing module/unit/logic 528 may represent any of the components described above. Processing module/unit/logic 528 may also reside, completely or at least partially, within memory 503 and/or within processor 501 during execution thereof by system 500, memory 503 and processor 501 also constituting machine-accessible storage media. Processing module/unit/logic 528 may further be transmitted or received over a network via network interface device(s) 505.

Computer-readable storage medium 509 may also be used to store some software functionalities described above persistently. While computer-readable storage medium 509 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 528, components and other features described herein can be implemented as discrete hardware components or integrated in the functionality of hardware components such as ASICS, FPGAs, DSPs or similar devices. In addition, processing module/unit/logic 528 can be implemented as firmware or functional circuitry within hardware devices. Further, processing module/unit/logic 528 can be implemented in any combination hardware devices and software components.

Note that while system 500 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method of authenticating a data processing system by a network core throughout a distributed environment, the method comprising:
obtaining curated telemetry data from the data processing system, the curated telemetry data comprising data points that meet data security criteria indicated by a data retention policy;
storing the curated telemetry data in a first activity log, the first activity log being maintained identically to a second activity log hosted by the data processing system based on the data retention policy;
attempting to improve a security profile of the first activity log based on the data retention policy to obtain an updated first activity log; and
performing a validation of the data processing system using a security questionnaire, the security questionnaire comprising security questions based on the updated first activity log.

2. The method of claim 1, further comprising:
prior to obtaining the curated telemetry data:
obtaining the data retention policy based on a data profile of the data processing system, wherein the data points that meet the data security criteria indicated by the data retention policy are candidate data points for generation of security questions to authenticate the data processing system; and
deploying the data retention policy to the data processing system and the network core.

3. The method of claim 2, wherein obtaining the data retention policy comprises:
establishing a secure connection to the data processing system;
obtaining raw telemetry data from the data processing system, the raw telemetry data not being previously curated by the data processing system;
performing an analysis of the raw telemetry data to obtain a result, the result indicating a degree of difficulty of predicting a measurement associated with each data point of the raw telemetry data by an adversary;
obtaining the data security criteria based on the result and the data profile of the data processing system; and
obtaining the data retention policy using, at least in part, the data security criteria.

4. The method of claim 3, wherein performing the analysis comprises:
obtaining a security score associated with each data point of the raw telemetry data,
wherein obtaining the security score comprises:
obtaining an inference as output from an inference model trained to generate security scores, the inference comprising the security score.

5. The method of claim 4, wherein the inference model performs anomaly detection, and the security score indicates a degree of anomalousness of each data point of the raw telemetry data.

6. The method of claim 4, wherein the inference model performs a variability analysis of the raw telemetry data, and the security score indicates a degree of variability associated with each feature of the raw telemetry data.

7. The method of claim 3, wherein the data retention policy comprises:
instructions for retaining a first portion of the data points that meet the data security criteria;
instructions for discarding a second portion of the data points that do not meet the data security criteria; and
instructions for discarding a third portion of the data points that meet the data security criteria and are similar to other data points previously marked for retention within a similarity threshold.

8. The method of claim 7, wherein the data retention policy further comprises:
instructions for performing a test for ascertaining whether the data retention policy has aged out.

9. The method of claim 1, further comprising:
obtaining an acknowledgement from the data processing system that indicates that the data retention policy has aged out;
initiating a data retention policy regeneration process in response to the acknowledgement to obtain an updated data retention policy; and
deploying the updated data retention policy to the data processing system and the network core.

10. The method of claim 1, wherein performing the validation of the data processing system comprises:
identifying an occurrence of an event indicating that the data processing system is to be authenticated;
obtaining a security questionnaire, based on the occurrence of the event, using the first activity log and a security risk level of the data processing system;
providing the security questionnaire to the data processing system;
obtaining a response, the response comprising answers to the security questions in the security questionnaire;
making a determination regarding whether each answer of the answers matches a pre-determined answer from a set of possible answers; and
in an instance of the determination in which each answer of the answers matches the pre-determined answer:
concluding that the data processing system is authentic.

11. The method of claim 1, wherein the curated telemetry data is obtained prior to a loss of a root of trust between the data processing system and the network core.

12. The method of claim 11, wherein the validation of the data processing system is performed without user intervention and concluding that the data processing system is authentic re-establishes the root of trust.

13. A non-transitory machine-readable medium having instructions stored therein, which when executed by a processor, cause the processor to perform operations for authenticating a data processing system by a network core throughout a distributed environment, the operations comprising:
obtaining curated telemetry data from the data processing system, the curated telemetry data comprising data points that meet data security criteria indicated by a data retention policy;
storing the curated telemetry data in a first activity log, the first activity log being maintained identically to a second activity log hosted by the data processing system based on the data retention policy;
attempting to improve a security profile of the first activity log based on the data retention policy to obtain an updated first activity log; and
performing a validation of the data processing system using a security questionnaire, the security questionnaire comprising security questions based on the updated first activity log.

14. The non-transitory machine-readable medium of claim 13, wherein the operations further comprise:
prior to obtaining the curated telemetry data:
obtaining the data retention policy based on a data profile of the data processing system, wherein the data points that meet the data security criteria indicated by the data retention policy are candidate data points for generation of security questions to authenticate the data processing system; and
deploying the data retention policy to the data processing system and the network core.

15. The non-transitory machine-readable medium of claim 14, wherein obtaining the data retention policy comprises:
establishing a secure connection to the data processing system;
obtaining raw telemetry data from the data processing system, the raw telemetry data not being previously curated by the data processing system;
performing an analysis of the raw telemetry data to obtain a result, the result indicating a degree of difficulty of predicting a measurement associated with each data point of the raw telemetry data by an adversary;
obtaining the data security criteria based on the result and the data profile of the data processing system; and
obtaining the data retention policy using, at least in part, the data security criteria.

16. The non-transitory machine-readable medium of claim 15, wherein performing the analysis comprises:
obtaining a security score associated with each data point of the raw telemetry data,
wherein obtaining the security score comprises:
obtaining an inference as output from an inference model trained to generate security scores, the inference comprising the security score.

17. A data processing system, comprising:
a processor; and
a memory coupled to the processor to store instructions, which when executed by the processor, cause the processor to perform operations for authenticating a data processing system by a network core throughout a distributed environment, the operations comprising:
obtaining curated telemetry data from the data processing system, the curated telemetry data comprising data points that meet data security criteria indicated by a data retention policy;
storing the curated telemetry data in a first activity log, the first activity log being maintained identically to a second activity log hosted by the data processing system based on the data retention policy;
attempting to improve a security profile of the first activity log based on the data retention policy to obtain an updated first activity log; and
performing a validation of the data processing system using a security questionnaire, the security questionnaire comprising security questions based on the updated first activity log.

18. The data processing system of claim 17, wherein the operations further comprise:
prior to obtaining the curated telemetry data:
obtaining the data retention policy based on a data profile of the data processing system, wherein the data points that meet the data security criteria indicated by the data retention policy are candidate data points for generation of security questions to authenticate the data processing system; and
deploying the data retention policy to the data processing system and the network core.

19. The data processing system of claim 18, wherein obtaining the data retention policy comprises:
establishing a secure connection to the data processing system;
obtaining raw telemetry data from the data processing system, the raw telemetry data not being previously curated by the data processing system;
performing an analysis of the raw telemetry data to obtain a result, the result indicating a degree of difficulty of predicting a measurement associated with each data point of the raw telemetry data by an adversary;
obtaining the data security criteria based on the result and the data profile of the data processing system; and
obtaining the data retention policy using, at least in part, the data security criteria.

20. The data processing system of claim 19, wherein performing the analysis comprises:
obtaining a security score associated with each data point of the raw telemetry data,
wherein obtaining the security score comprises:
obtaining an inference as output from an inference model trained to generate security scores, the inference comprising the security score.
